(19) United States
(12) Patent Application Publication
(10) Pub. No.: US 2026/0267353 A1
(43) Pub. Date: Sep. 10, 2026

(54) TRAVELING ASSISTANCE SYSTEM

(71) Applicant: TOYOTA JIDOSHA KABUSHIKI KAISHA, Toyota-shi (JP)

(72) Inventor: Kunihiko USUI, Fuji-shi (JP)

(73) Assignee: TOYOTA JIDOSHA KABUSHIKI KAISHA, Toyota-shi (JP)

(21) Appl. No.: 19/449,710

(22) Filed: Jan. 15, 2026

(30) Foreign Application Priority Data
Mar. 6, 2025 (JP) 2025-035935

(51) Int. Cl. G05D 1/686; G05D 1/689; G05D 109/20; G05D 111/10

(52) U.S. Cl. CPC G05D 1/686; G05D 1/689; G05D 2109/20; G05D 2111/10

(57) ABSTRACT

Shooting conditions are set, including set flight coordinates, set horizontal shooting angle, set vertical shooting angle, and set shooting range, with respect to a vehicle, and shooting conditions maintenance control is performed to control a drone to maintain the shooting conditions based on vehicle coordinates and vehicle orientation. This enables the drone to be controlled to maintain the shooting conditions, and shot images are provided to the vehicle, and accordingly surroundings of the vehicle are confirmed with consistency.

### CROSS-REFERENCE TO RELATED APPLICATION

This application claims priority to Japanese Patent Application No. 2025-035935 filed on Mar. 6, 2025. The disclosure of the above-identified application, including the specification, drawings, and claims, is incorporated by reference herein in its entirety.

### BACKGROUND

### 1. Technical Field

The present disclosure relates to a traveling assistance system that provides a vehicle with shot images of surroundings of the vehicle shot by a drone.

### 2. Description of Related Art

A traveling assistance system is known that enables a vehicle to confirm the surroundings thereof by providing the vehicle with shot images shot using a flying object that is capable of unmanned flying in the air, such as a drone or the like. A vehicle driving assistance system described in Japanese Patent No. 5819555 is one such example. Also, WO 2020/170534 discloses technology for calculating shooting conditions (such as drone position, camera shooting angle, zoom ratio, etc.) based on a plurality of planned shooting locations that is set in advance, and position information of a vehicle.

### SUMMARY

Now, the vehicle driving assistance system described in Japanese Patent No. 5819555 shoots an area surrounding an object vehicle from the air, and accordingly blind spots around the object vehicle cannot be confirmed, and when there is an obstruction in a blind spot, there is a risk that the obstruction will strike the vehicle, causing damage to the vehicle, or that the vehicle will run up onto the obstruction and become immovable.

In order to address this issue, it is conceivable to use the technology of WO 2020/170534 to set the planned shooting positions of the drone to positions that avert blind spots, and calculate shooting conditions based on planned shooting positions and position information of the vehicle to perform shooting. However, when performing shooting based on planned shooting positions, on public road surfaces that are not racing circuits, particularly on underdeveloped roads and so forth with many obstructions, and when taking multiple routes is likely, relative positions of the drone, the vehicle, and the obstructions change, which is problematic in that images that should be confirmed in real time, such as the clearance or the like between the vehicle and obstructions, for example, cannot be consistently obtained. Also, there is a problem in that when a driver wants to change object locations for confirming clearance, confirmation directions (shooting angle), or the like, in accordance with traveling conditions, making such changes is difficult for the driver.

The present disclosure has been made in light of the above circumstances, and an object thereof is to provide a traveling assistance system that can consistently confirm surroundings of a vehicle using shot images that are shot by a drone.

The gist of a first disclosure is (a) a traveling assistance system that provides a vehicle with a shot image of surroundings of the vehicle that is shot by a drone, in which the traveling assistance system (b) sets shooting conditions, including a relative position, a shooting angle, and a shooting range, with respect to the vehicle, and (c) performs shooting conditions maintenance control to control the drone so as to maintain the shooting conditions, based on position information of the vehicle and direction of the vehicle.

According to the first disclosure, shooting conditions including the relative position, the shooting angle, and the shooting range, with respect to the vehicle, are set, and the shooting conditions maintenance control is performed to control the drone to maintain the shooting conditions based on the position information of the vehicle and the direction of the vehicle. This enables the drone to be controlled to maintain the shooting conditions, and the shot images are provided to the vehicle, and accordingly the surroundings of the vehicle are confirmed with consistency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a traveling assistance system to which the present disclosure is applied;

FIG. 2 is a diagram illustrating an example of setting items for shooting conditions;

FIG. 3 is a diagram illustrating an example of a case in which the shooting conditions in FIG. 2 are applied to an absolute coordinate system in which position information is detected;

FIG. 4 is a flowchart showing an example of control operations of the traveling assistance system;

FIG. 5 is a flowchart showing an example of the control operations of shooting conditions maintenance control executed as a subroutine in the flowchart in FIG. 4; and

FIG. 6 is a diagram illustrating operations of a conventional example of a traveling assistance system.

### DETAILED DESCRIPTION OF EMBODIMENTS

Embodiments of the present disclosure will be described below in detail with reference to the drawings.

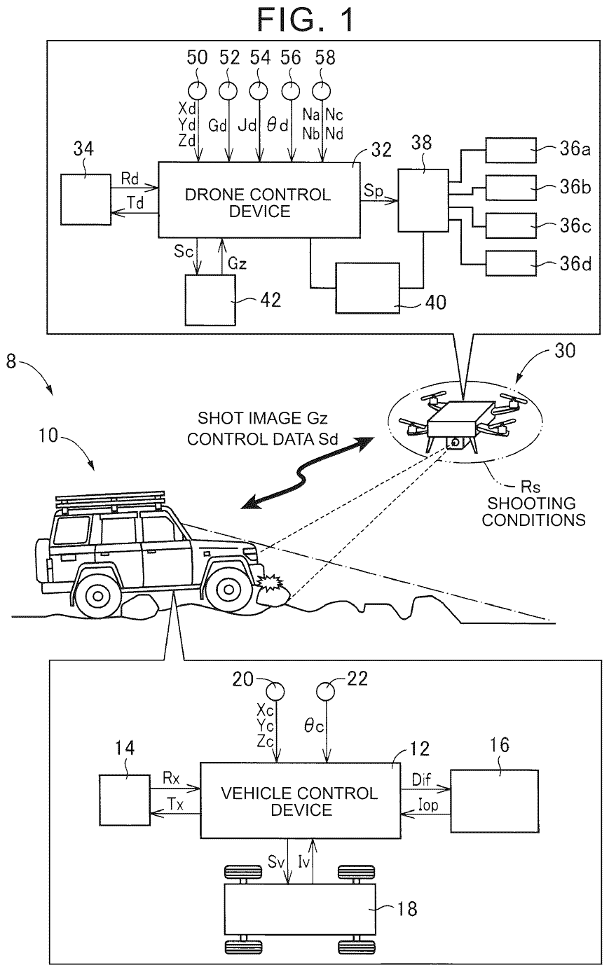

FIG. 1 is a diagram illustrating a schematic configuration of a traveling assistance system 8 to which the present disclosure is applied. The traveling assistance system 8 includes a vehicle control device 12, a communication device 14, a display device 16, and so forth, with which a vehicle 10 is provided, and a drone 30.

A schematic configuration of the vehicle 10 is illustrated in a balloon at the bottom of FIG. 1. The vehicle 10 includes a vehicle main unit 18. The vehicle main unit 18 includes a motive power source, a motive power transmission device, wheels, and so forth, which are omitted from illustration, and the vehicle 10 travels along with the vehicle main unit 18. The vehicle control device 12 is a control device that controls each part of the vehicle 10, and is configured including a so-called microcomputer. The vehicle control device 12 performs various types of control on the vehicle main unit 18 related to traveling.

The communication device 14 communicates with the drone 30. For example, reception of shot images Gz shot by the drone 30, and transmission and reception of control data Sd related to control of the drone 30 are performed using suitable communication means such as low-power data communication, wireless LAN, mobile communication, and so forth.

The display device 16 is, for example, a device such as a multi-information display that displays various types of information to a driver, or the like, and in a state in which the traveling assistance system 8 is activated, the display device 16 displays an operating menu, the images Gz shot by the drone 30, and so forth. The display device 16 also includes an input device such as, for example, a touch panel or the like for the driver to operate.

The vehicle control device 12 is supplied with each of various types of signals and the like, (e.g., reception data Rx from the drone 30, operation signals Iop from input equipment with which the display device 16 is equipped, vehicle state signals Iv which are various types of detection signals from the vehicle main unit 18, vehicle coordinates C (Xc, Yc, Zc) indicating the current position of the vehicle 10, vehicle orientation θc indicating the orientation ahead of the vehicle 10, and so forth) based on detection values and so forth from various types of devices, sensors, and so forth, with which the vehicle 10 is equipped (e.g., communication device 14, display device 16, vehicle main unit 18, vehicle position sensor 20, vehicle orientation sensor 22, and so forth). The vehicle coordinates C (Xc, Yc, Zc) correspond to “position information of vehicle” according to the present disclosure, and the vehicle orientation θ corresponds to “direction of vehicle” according to the present disclosure.

The vehicle coordinates C (Xc, Yc, Zc) are detected by the vehicle position sensor 20, suitably using well-known methods such as the Global Positioning System (GPS), global navigation satellite system (GNSS), real time kinematic positioning (RTK), or the like, and three-dimensional coordinates in an absolute coordinate system are acquired. Also, the vehicle orientation θc is detected as a value in a range of 0≤θc<2π (360 °) when a reference orientation is set to 0.

The vehicle control device 12 outputs each of various types of command signals (e.g., transmission data Tx to the drone 30, display data Dif to the display device 16, vehicle control signals Sv which are various control signals to the vehicle main unit 18, etc.) to each device (e.g., communication device 14, display device 16, vehicle main unit 18, etc.) with which the vehicle 10 is equipped.

A schematic configuration of the drone 30 is illustrated in a balloon at the bottom of FIG. 1. The drone 30 is equipped with a drone control device 32, a communication device 34, four propellers 36 (36a, 36b, 36c, 36d), a propeller drive device 38, a battery 40, a camera 42, and so forth.

The drone control device 32 is a control device that controls each part of the drone 30, and is configured including a so-called microcomputer. The communication device 34 is a device that communicates with the vehicle 10, and suitable communication means is used, in the same way as with the communication device 14. The propellers 36 (36a, 36b, 36c, 36d) are each disposed at four corners of a housing of the drone 30, in directions generating upward lift force upward in a vertical direction, and are driven by the propeller drive device 38. The battery 40 supplies electric power to drive the propellers 36 and electric power to run various types of devices that the drone 30 is equipped with.

The camera 42 is disposed at a bottom of the housing of the drone 30, such that a shooting direction of the camera is forward of the drone 30. The camera 42 also includes a mechanism for controlling a vertical shooting angle θv, which is up and down tilt of the shooting direction, and the shooting range θz, which is zoom ratio. The vertical shooting angle θv and shooting range θz are each controllable within a predetermined range.

The drone control device 32 is supplied with each of various types of signals (e.g., reception data Rd from the vehicle 10, shot images Gz shot by the camera 42, drone coordinates D (Xd, Yd, Zd) indicating the current position of the drone 30, three-axis acceleration Gd of the drone 30, three-axis angular acceleration Jd of the drone 30, drone orientation θd indicating the forward orientation of the drone 30, propeller rotation speeds Na, Nb, Nc, Nd of the respective propellers 36 (36a, 36b, 36c, 36d), etc.) and so forth, based on detection values and so forth from various devices and sensors that the drone 30 is equipped with (e.g., communication device 34, camera 42, drone position sensor 50, acceleration sensor 52, gyro sensor 54, drone orientation sensor 56, propeller rotation sensor 58, etc.), and so forth.

The drone position sensor 50 detects the drone coordinates D (Xd, Yd, Zd), suitably using methods such as GPS, GNSS, RTK, and so forth, in the same way as with the vehicle position sensor 20, and three-dimensional coordinates in the absolute coordinate system are acquired. Also, the drone orientation θd is detected as a value in a range of 0≤θd<2π (360 °) when the reference direction is set to 0, in the same way as with the vehicle orientation θc.

The drone control device 32 outputs each of various types of command signals (e.g., transmission data Td to the vehicle 10, propeller drive control signals Sp that control the driving of each of the propellers 36 (36a, 36b, 36c, 36d), camera control signals Sc that control the vertical shooting angle θv and shooting range θz of the camera 42, etc.) to each device (e.g., communication device 34, propeller drive device 38, camera 42, and so forth) that the drone 30 is equipped with.

The drone control device 32 controls flight of the drone 30, such as moving, hovering in mid-air, and so forth, by controlling the propeller rotation speeds Na, Nb, Nc, and Nd of each of the propellers 36 (36a, 36b, 36c, and 36d) based on, for example, detected values such as drone coordinates D, three-axis acceleration Gd, three-axis angular acceleration Jd, drone orientation θd, and so forth.

The traveling assistance system 8 causes the drone 30 to track the vehicle 10 based on the vehicle coordinates C and the vehicle orientation θc, and provides the vehicle 10 with shot images Gz of the surroundings of the vehicle 10, shot by the camera 42 of the drone 30. These operations are performed through coordinated control between the vehicle control device 12 and the drone control device 32.

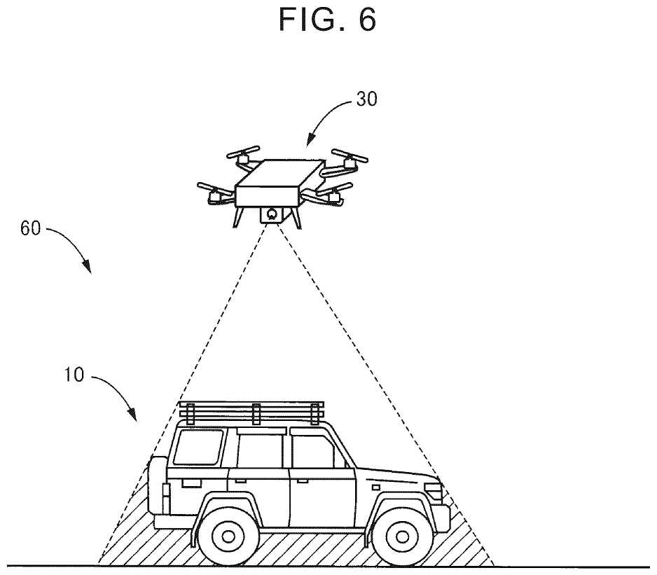

FIG. 6 is a diagram illustrating operations of a conventional traveling assistance system 60. In the traveling assistance system 60, the drone 30 shoots the surroundings of the vehicle 10 from above, and therefore cannot see blind spots of the vehicle 10, as indicated by the shaded areas in FIG. 6, and accordingly when there is an obstruction in a blind spot, there is a risk that the obstruction will strike the vehicle 10 and damage the vehicle 10, or that the vehicle 10 will run up onto the obstruction and become undriveable. In order to address this issue, it is conceivable to use the aforementioned technology of WO 2020/170534 to set the planned shooting positions of the drone 30 to positions averting blind spots, and perform shooting based on the planned shooting positions and the vehicle coordinates C to perform shooting. However, when performing shooting based on the planned shooting positions, on public road surfaces that are not racing circuits, particularly on underdeveloped roads and so forth with many obstructions, in a case in which taking multiple routes is likely, the relative positions of the drone 30, the vehicle 10, and the obstructions change, which is problematic in that the shot images Gz that should be confirmed in real time, such as the clearance and so forth between the vehicle 10 and obstructions, cannot be consistently obtained. Also, there is a problem in that when a driver wants to change object locations for confirming clearance, confirmation directions (shooting angle), or the like, in accordance with traveling conditions, making such changes is difficult for the driver.

Returning to FIG. 1, the area below a long dashed short dashed line in front of the vehicle 10 in FIG. 1, for example, is a blind spot that the driver cannot see directly. In order to ensure consistent visibility of the surroundings the vehicle 10, including these blind spots, the traveling assistance system 8 sets shooting conditions Rs (indicated by a long dashed double-short dashed line) described below, which include the position, the angle, and so forth, for shooting relative to the vehicle 10, and controls the flight of and the shooting by the drone 30 so as to maintain the shooting conditions Rs.

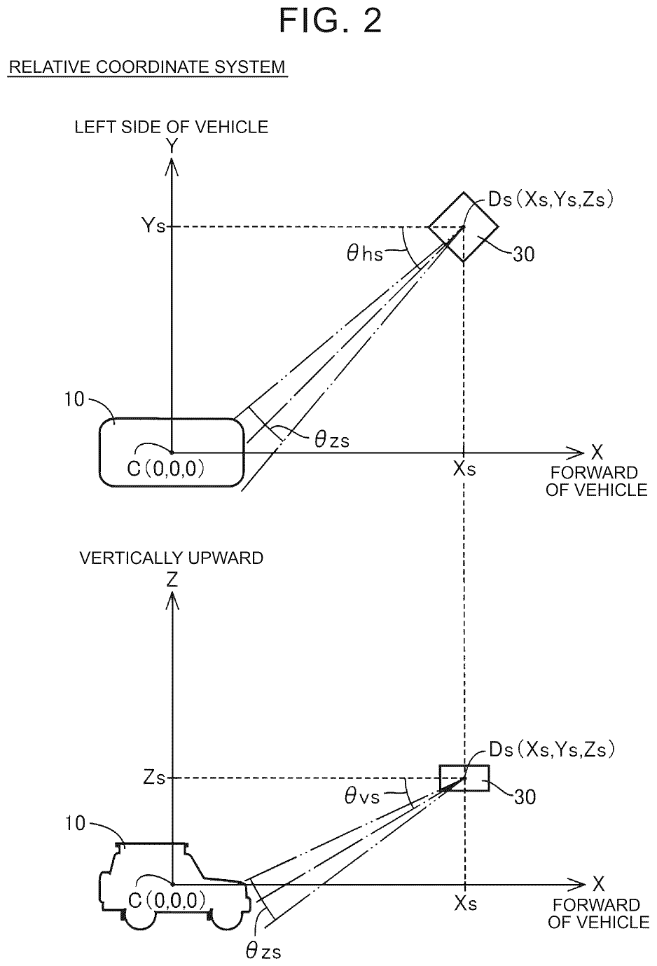

FIG. 2 is a diagram illustrating an example of setting items for the shooting conditions Rs, in which the shooting conditions Rs are set in a relative coordinate system in which the vehicle 10 is the origin (0,0,0), where forward of the vehicle 10 is a positive direction of the X axis, left-side of the vehicle 10 in a vehicle width direction is a positive direction of the Y axis, and vertically upward is a positive direction of the Z axis. The shooting conditions Rs include set flight coordinates Ds (Xs, Ys, Zs), a set horizontal shooting angle θhs, a set vertical shooting angle θvs, and a set shooting range θzs. The set flight coordinates Ds (Xs, Ys, Zs) set the relative position of the drone 30 with respect to the vehicle 10, and are set by coordinate values Xs, Ys, and Zs on the coordinate axes. Also, as illustrated in the upper part of FIG. 2, the set horizontal shooting angle θhs sets the horizontal orientation forward of the drone 30 relative to the vehicle 10, i.e., the shooting direction of the camera 42, when the vehicle 10 is viewed from vertically above, and is set, for example, as indicated by θhs in the drawings, as an angle from a plane parallel to a XZ plane passing through the set flight coordinates Ds. The set vertical shooting angle θvs, as illustrated in the lower part of FIG. 2, sets up-down tilt of the shooting direction of the camera 42 when the vehicle 10 is viewed from a right side in the vehicle width direction, and is set, for example, as indicated by θvs in the drawings, as an angle from a plane parallel to the XY plane passing through the set flight coordinates Ds. The set shooting range θzs is used to set the shooting range of the camera 42, and is set at an angle that sets the shooting range, for example, as indicated by θzs in the drawings. The set flight coordinates Ds correspond to “relative position” of the present disclosure, and the set horizontal shooting angle θhs and the set vertical shooting angle θvs correspond to the “shooting angle” of the present disclosure, respectively.

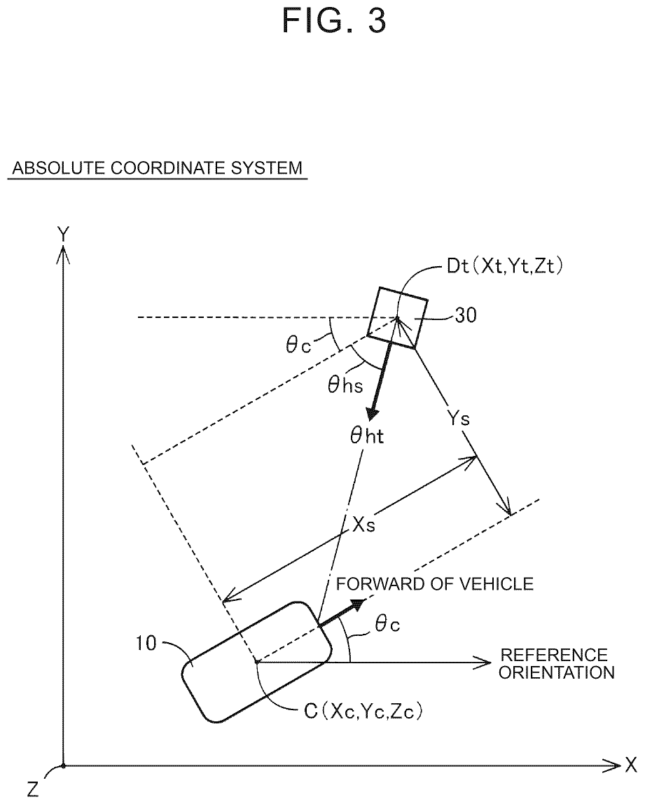

The shooting conditions Rs in FIG. 2 are set in the relative coordinate system with the vehicle 10 as the origin, and accordingly shooting conditions maintenance control RC, which controls the drone 30 to maintain the shooting conditions Rs, is performed by converting the vehicle coordinates C (Xc, Yc, Zc), the drone coordinates D (Xd, Yd, Zd), and so forth, into coordinates and shooting angles in the absolute coordinate system in which detection thereof is performed. FIG. 3 is a diagram illustrating an example of a case in which the shooting conditions Rs are applied to the absolute coordinate system. FIG. 3 is a diagram of the vehicle 10 as viewed vertically from above, and for the sake of convenience of description, the reference directions of the vehicle orientation θc and the drone orientation θd are set to the positive direction of the X axis.

As illustrated in FIG. 3, when the vehicle 10 is at the vehicle coordinates C (Xc, Yc, Zc) and also in the vehicle orientation θc, target flight coordinates Dt (Xt, Yt, Zt) can be calculated, using the following Expression (1), Expression (2), and Expression (3), for example, in which the coordinates to which the set flight coordinates Ds are applied in the absolute coordinate system are defined as target flight coordinates Dt.

$$Xt = Xc + Xs \times cos θ c - Ys \times sin θ c \qquad ( 1 )$$

$$Yt = Yc + X s \times sin 0 c + Y s \times … \qquad ( 2 )$$

$$Zt = Zc + Zs \qquad ( 3 )$$

Also, a target shooting orientation θht which sets the horizontal direction of the shooting direction of the camera 42, i.e., the forward orientation of the drone 30, is calculated, for example, by the following Expression (4).

$$When θ c + θ hs < π ( 180 ° ) , then θ ht = θ c + θ hs + π \qquad ( 4 )$$

$$When θ c + θ hs \geq π , then θ ht = θ c + θ hs - π$$

Also, the values set in the shooting conditions Rs for the set vertical shooting angle θvs and the set shooting range θzs are also inherited in the absolute coordinate system. Thus, the shooting conditions Rs are applied to the absolute coordinate system based on the vehicle coordinates C (Xc, Yc, Zc) and the vehicle orientation θc of the vehicle 10.

Also, when the vehicle 10 illustrated in FIG. 3 moves by a change amount ΔC (ΔX, ΔY, ΔZ) without changing the vehicle orientation θc, to vehicle coordinates C′ (Xc+ΔX, Yc+ΔY, Zc+ΔZ), target flight coordinates Dt′ (Xt′, Yt′, Zt′) and target shooting orientation θht′ corresponding to the vehicle coordinate C′ are calculated as follows from Expressions (1) to (4).

$${Xt}^{′} = Xc + Δ X + X s \times cos θ c - Ys \times sin θ c = Xt + Δ X$$

$${Yt}^{′} = Yc + ΔY + Xs \times cos θ c + Ys \times cos θ c = Yt + Δ Y$$

$${Zt}^{′} = Zc + Δ Z + Z s = Z t + Δ Z$$

$$θ {ht}^{′} = θ c + θ hs + π or θ c + θ hs - π = θ ht$$

Therefore, when the vehicle orientation θc does not change, the target flight coordinates Dt′ are coordinates obtained by adding the change amount ΔC to the target flight coordinates Dt. That is to say, the shooting conditions Rs are maintained by causing the drone 30 to move by an amount equal to the change amount ΔC. This quickens flight control of the drone 30 when the vehicle orientation θc does not change, and quickens tracking responsiveness of the drone 30 with respect to the movement of the vehicle 10.

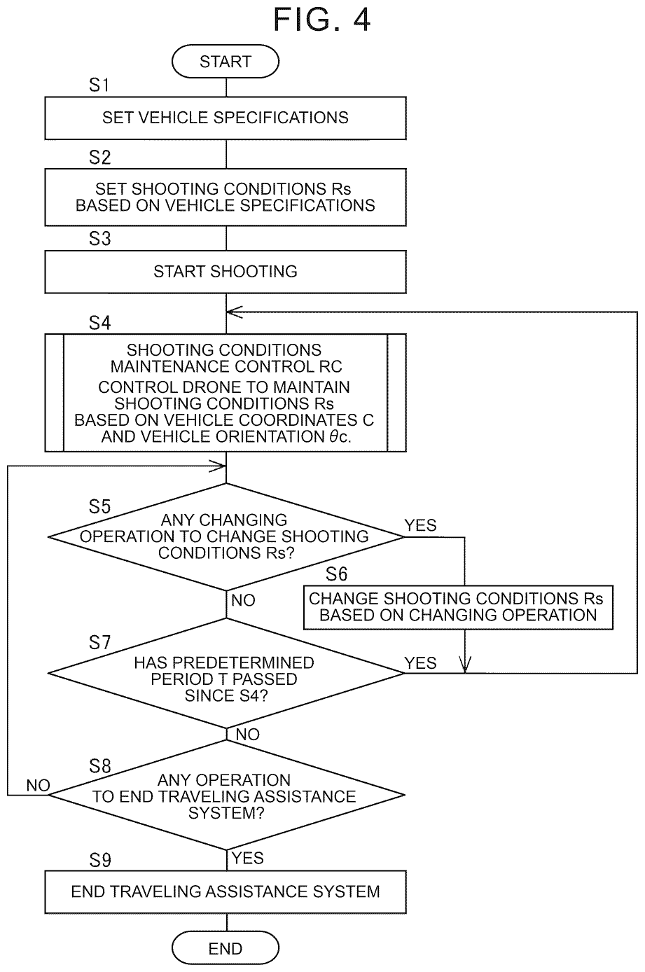

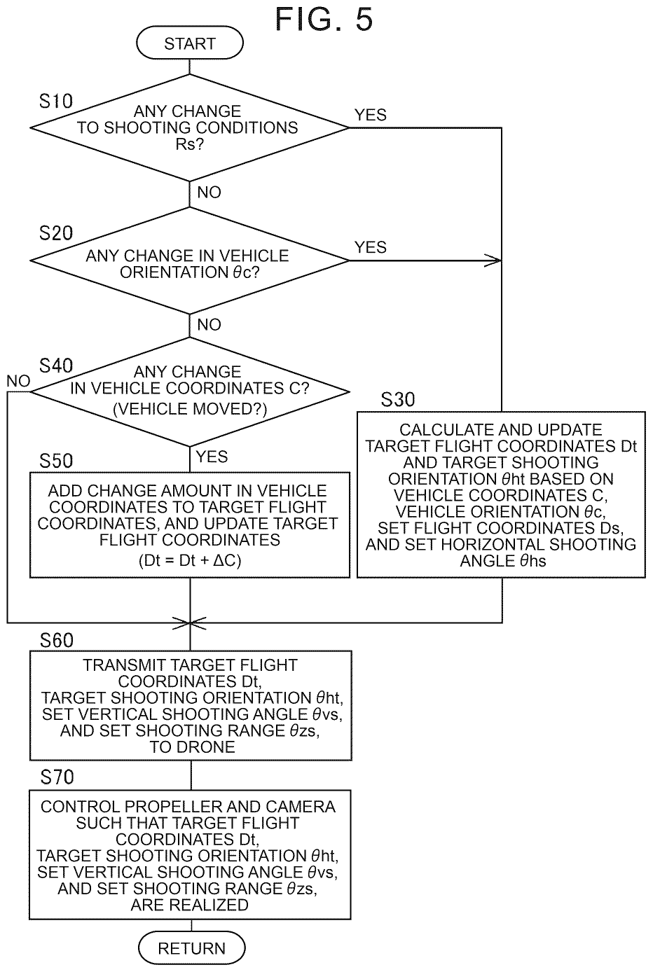

FIG. 4 is a flowchart showing an example of control operations of the traveling assistance system 8, which is executed when the traveling assistance system 8 is started up, for example. Also, FIG. 5 is a flowchart showing an example of control operations of the shooting conditions maintenance control RC executed as a subroutine in the flowchart in FIG. 4.

In FIG. 4, each step in the flowchart, other than step (hereinafter, step will be omitted) S4 (subroutine), corresponds to a function of the vehicle control device 12. First, in S1, vehicle specifications Clwh of the vehicle 10 are set, and then in S2, the shooting conditions Rs are set based on the vehicle specifications Clwh.

The vehicle specifications Clwh are information such as overall length l, width w, height h, and so forth, of the vehicle 10, for example. The shooting conditions Rs are set to initial values suitable for shooting, by applying values of the vehicle specification Clwh to a calculation formula or map that is set in advance, for example. Also, the vehicle specifications Clwh are set by a suitable method such as automatic setting from values stored in the vehicle 10 in advance, settings being input by the driver, or the like. Setting the shooting conditions Rs based on the vehicle specifications Clwh enables the shooting conditions Rs to be suitably set in accordance with the vehicle specifications Clwh, such as increasing the set flight coordinates Ds or the set shooting range θzs when the vehicle width w or the height h of the vehicle 10 is great, for example.

Next, in S3, the vehicle control device 12 transmits control data Sd that commands starting of shooting to the drone control device 32, and shooting by the drone 30 is started. When an image is shot, the shot image Gz of the camera 42 is transmitted from the drone 30 to the vehicle 10 (vehicle control device 12), and then transmitted from the vehicle control device 12 to the display device 16 as the display data Dif, and is displayed.

Next, in S4, the subroutine is executed to perform the shooting conditions maintenance control RC which controls the drone 30 so as to maintain the shooting conditions Rs based on the vehicle coordinates C and the vehicle orientation θc.

In the subroutine of FIG. 5, each step from S10 to S60 corresponds to a function of the vehicle control device 12, and S70 corresponds to a function of the drone control device 32. First, in S10, determination is made regarding whether there is a change in the shooting conditions Rs, and in S20, determination is made regarding whether there is a change in the vehicle orientation θc. When the determination in S10 or S20 is affirmative, at S30, the target flight coordinates Dt and the target shooting orientation θht are calculated and updated based on the vehicle coordinates C, the vehicle orientation θc, the set flight coordinates Ds, and the set horizontal shooting angle θhs, for example, using Expressions (1) to (4).

When the determinations in S10 and S20 are negative, determination is made in

S40 whether there is a change in the vehicle coordinates C, i.e., whether the vehicle 10 has moved. When the determination in S40 is affirmative, the change amounts ΔC in the vehicle coordinates C are added to the original target flight coordinates Dt, and the target flight coordinates Dt are updated (Dt=Dt+ΔC).

When the determination in S40 is negative, or after S30 and S50, the flow transitions to S60, in which target flight coordinates Dt, target shooting orientation θht, set vertical shooting angle θvs, and set shooting range θzs are transmitted from the vehicle control device 12 to the drone control device 32, and then in S70, the drone control device 32 outputs the propeller drive control signals Sp to the propeller drive device 38, and camera control signals Sc to the camera 42, such that target flight coordinates Dt, target shooting orientation θht, set vertical shooting angle θvs, and set shooting range θzs are obtained, and this subroutine then returns. By executing this subroutine (shooting conditions maintenance control RC), the drone 30 is controlled to maintain the shooting conditions Rs.

Returning to the main routine in FIG. 4, in S5, determination is made regarding whether there is a changing operation to change the shooting conditions Rs. When the determination in S5 is affirmative, in S6, the shooting conditions Rs are changed based on the changing operation, and then the flow transitions to S4, in which the shooting conditions maintenance control RC is executed again. When there is a changing operation performed for the shooting conditions Rs, S4 to S6 are repeated, and accordingly the drone 30 is controlled and the shot image Gz also changes in accordance with the change in the shooting conditions Rs. Thus, the shooting conditions Rs can be changed in real time during the shooting conditions maintenance control RC. Also, the shooting conditions Rs that are changed are maintained even when the vehicle 10 moves or the like, and accordingly, the burden on an operator regarding changing the shooting conditions Rs is reduced.

The changing operation for changing the shooting conditions Rs is performed in a suitable manner that enables the operator to change the shooting conditions Rs while confirming the shot image Gz by, for example, performing operations such as touch selection, scrolling, pinching in, pinching out, and so forth, on an input device such as a touch panel provided on the display device 16 on which the shot image Gz is displayed, thereby changing an object area or confirmation direction (shooting angle), by operating a settings menu or settings buttons for settings items of the shooting conditions Rs, or the like.

When the determination in S5 is negative, determination is made in S7 regarding whether a predetermined period T has elapsed since the subroutine in S4 was started. When the determination in S7 is affirmative, the flow transitions to S4, where the shooting conditions maintenance control RC is executed again. The predetermined period T is a set value that is determined in advance by design or experimentation in order to ensure the flight stability of the drone 30 and the tracking responsiveness and so forth with respect to the vehicle 10, and is set to a period of, for example, several tens of milliseconds or so.

When the determination in S7 is negative, determination is made in S8 regarding whether an operation to end the traveling assistance system 8 has been performed. When the determination in S8 is negative, the flow transitions to S5, and when the determination in S8 is affirmative, the traveling assistance system 8 ends in S9, and this routine ends.

In this way, in the traveling assistance system 8, the drone 30 is controlled to maintain the shooting conditions Rs, and the shot image Gz is provided to the vehicle 10, such that the driver can consistently monitor clearance between the vehicle 10 and obstruction, for example, in real time. For example, when there is a concern that the ground or obstructions on the ground (such as uneven road surfaces, rocks, rubble, or other objects that may come into contact with the vehicle while traveling and impede traveling) may come into contact with the vehicle 10 (such as bumper, differential, or the like), the driver can avert contact by confirming the situation before contact occurs. Also, even when contact is unavoidable, the driver can aim for contact at an intended location, and confirm the extent of contact while traveling, thereby limiting damage to within an anticipated range. Further, in a case of unintended contact with an obstruction (contact at a position out of sight), the driver can confirm the contact location with the obstruction from the shot image Gz, and by knowing the contact location, the driver can correctly determine the direction in which the vehicle 10 should move, thereby minimizing damage, or averting a maximal situation in which the vehicle becomes immovable. Also, when confirming whether the vehicle will become immovable, the driver may be injured by exiting the vehicle 10 to perform confirmation in a location with obstructions or a rough road surface, but confirmation using the shot image Gz enables the driver to stay inside the vehicle 10 and to perform confirmation safely.

Also, when communication with the drone 30 is lost or the drone 30 performs flight to avert an obstruction (safe-side override) or the like, during shooting, causing the positional relation between the drone 30 and the vehicle 10 to be disturbed, it will be difficult to restore the drone to its shooting state in a system that controls the flight of the drone 30 using image recognition or the like, because the object to be recognized will be lost. However, with the traveling assistance system 8, the drone 30 is controlled by calculating the target flight coordinates Dt (absolute coordinates), and therefore can be restored to the shooting state. Similarly, even when the drone 30 is replaced or battery replacement is performed during shooting, restoration can be performed without any operations or reconfiguration for restoration.

As described above, according to the traveling assistance system 8 of the present embodiment, the shooting conditions Rs including the set flight coordinates Ds (Xs, Ys, Zs), the set horizontal shooting angle θhs, the set vertical shooting angle θvs, and the set shooting range θzs, for the vehicle 10, are set, and the shooting conditions maintenance control RC is performed to control the drone 30 to maintain the shooting conditions Rs based on the vehicle coordinates C (Xc, Yc, Zc) and the vehicle orientation θc. This enables the drone 30 to be controlled to maintain the shooting conditions Rs, and the shot image Gz is provided to the vehicle 10, and accordingly the surroundings of the vehicle 10 can be confirmed with consistency.

Also, according to the traveling assistance system 8 of the present embodiment, the shooting conditions Rs are set based on the vehicle specifications Clwh of the vehicle 10. This enables the shooting conditions Rs to be set suitably in accordance with the vehicle specifications Clwh.

Also, according to the traveling assistance system 8 of the present embodiment, the shooting conditions Rs can be changed during the shooting conditions maintenance control RC. Accordingly, the shooting conditions Rs can be changed in real time during the shooting conditions maintenance control RC. Also, the shooting conditions Rs that are changed are maintained even when the vehicle 10 moves or the like, and accordingly, the burden on an operator regarding changing the shooting conditions Rs is reduced.

Also, according to the traveling assistance system 8 of the present embodiment, when the vehicle orientation θc does not change, the shooting conditions maintenance control RC is performed by moving the drone 30 by an amount equal to the change amount ΔC (ΔX, ΔY, ΔZ). This quickens flight control of the drone 30 when the vehicle orientation θc does not change, and quickens tracking responsiveness of the drone 30 with respect to the movement of the vehicle 10.

Although the embodiment of the present disclosure has been described in detail above with reference to the drawings, the present disclosure can also be applied to other embodiments.

For example, in the above-described embodiment, in the subroutine (FIG. 5) that performs the shooting conditions maintenance control RC, the control operations from S10 to S60 are performed by the vehicle control device 12, and the control operation of S70 is performed by the drone control device 32. However, an arrangement may be made in which, when the subroutine is started, the drone control device 32 receives the shooting conditions Rs, the vehicle orientation θc, and the vehicle coordinates C, and performs the control operations of the entire subroutine, for example. The allocation of the control operations between the vehicle control device 12 and the drone control device 32 may be carried out as suitable, depending on system requirements such as processing performance, stability, and so forth.

Also, in the above-described embodiment, communication of the shot images Gz between the vehicle 10 and the drone 30 and the control data Sd related to the control of the drone 30, and so forth, is carried out between the vehicle 10 and the drone 30, but this is not restrictive, and the communication may also be communication via a server or the like, for example.

Also, in the above-described embodiment, the set flight coordinates Ds are set using coordinate values on the XYZ axes, i.e., the Cartesian coordinate values Xs, Ys, and Zs, but are not limited to this, and may be set using, for example, spherical coordinate values (polar coordinate values), defined by the radius vector (distance), azimuth angle, and polar angle, or the like. The Cartesian coordinate values and the spherical coordinate values can be mutually converted, and the present disclosure is also applicable to spherical coordinate values.

Also, in the above-described embodiment, the drone 30 is provided with the four propellers 36 (36a, 36b, 36c, 36d), but this is not restrictive. The present disclosure can be applied to any flying object that can be controlled by flight control to hover in mid-air, move, and so forth.

Also, in the above-described embodiment, the horizontal shooting direction of the camera 42 is controlled by the forward orientation of the drone 30 (drone orientation θd), but this is not restrictive, and for example, the camera 42 may be provided with a mechanism for controlling the horizontal shooting direction, or the like.

It should be noted that the above is merely one embodiment, and the present disclosure can be implemented in forms with various modifications and improvements made based on the knowledge of those skilled in the art.

What is claimed is:

1. A traveling assistance system that provides a vehicle with a shot image of surroundings of the vehicle that is shot by a drone, wherein the traveling assistance system
sets shooting conditions, including a relative position, a shooting angle, and a shooting range, with respect to the vehicle, and
performs shooting conditions maintenance control to control the drone so as to maintain the shooting conditions, based on position information of the vehicle and direction of the vehicle.

2. The traveling assistance system according to claim 1, wherein the shooting conditions are set based on vehicle specifications of the vehicle.

3. The traveling assistance system according to claim 1, wherein the shooting conditions are changeable during the shooting conditions maintenance control.

4. The traveling assistance system according to claim 1, wherein,
when the direction of the vehicle does not change, the shooting conditions maintenance control is performed by causing the drone to move by the same amount as a change amount in the position information of the vehicle.
